(19) United States
(12) Patent Application Publication
(10) Pub. No.: US 2023/0244445 A1
(43) Pub. Date: Aug. 3, 2023

(54) TECHNIQUES AND DEVICES FOR EFFICIENT MONTGOMERY MULTIPLICATION WITH REDUCED DEPENDENCIES

(71) Applicant: NVIDIA Corporation, Santa Clara, CA (US)

(72) Inventors: Shuai Wang, Shanghai (CN); Chen Yao, Shanghai (CN); Xiao Wu, Shanghai (CN); Yuji Qian, Shanghai (CN); Rongzhe Zhu, Shanghai (CN); Xixi Xie, Shanghai (CN)

(21) Appl. No.: 17/707,609

(22) Filed: Mar. 29, 2022

Related U.S. Application Data
(63) Continuation of application No. PCT/CN2022/074570, filed on Jan. 28, 2022.

(51) Int. Cl. G06F 7/487

(52) U.S. Cl. CPC G06F 7/4876

(57) ABSTRACT

Disclosed are apparatuses, systems, and techniques to perform and facilitate fast and efficient modular computational operations, such as Montgomery multiplication with reduced interdependencies, using optimized processing resources.

### RELATED APPLICATIONS

The application claims the benefit of priority under 35 U.S.C. 365 to the international application PCT/CN2022/074570, filed Jan. 28, 2022 with the China National Intellectual Property Administration, which is hereby incorporated in its entirety.

### TECHNICAL FIELD

At least one embodiment pertains to technologies used to perform and facilitate modular computational operations. For example, at least one embodiment pertains to computational methods and devices that may be used to accelerate modular multiplications that use Montgomery multiplication and reduction techniques.

### BACKGROUND

In public-key cryptography systems, a computing device may perform operations on large binary numbers as part of various algorithms, such as Rivest-Shamir-Adelman (RSA), Diffie-Hellman (DH), elliptic curve cryptography (ECC) algorithms, etc., to encrypt and/or decrypt secret messages, digital signature algorithms (DSA) to authenticate messages, and so on. Cryptographic algorithms typically involve modular arithmetic operations, in which integers are wrapped around a circle of length P (the ring Z_{P}), so that any two numbers that differ by P (or any other integer of P) are treated as the same number. A typical multiplication operation of two numbers, A and B, can generate a number AB that is much larger than P. Reducing the generated number to the ring Z_{P} amounts to determining a residue of the division of AB by P and can be a computationally expensive operation. Performance of even a single instance of a cryptographic algorithm can involve a large number of these or other (e.g., addition, subtraction, exponentiation, division, etc.) modular operations. Furthermore, typical applications can include a large number of instances of encryption and decryption of large amounts of data that can consume significant processing resources.

### BRIEF DESCRIPTION OF DRAWINGS

FIG. 1 is a block diagram of an example computer device that performs efficient Montgomery multiplication with reduced interdependencies, in accordance with at least some embodiments;

FIG. 2 illustrates an example data flow in the course of performance of efficient Montgomery multiplication with reduced interdependencies, in accordance with at least some embodiments;

FIG. 3 is a high-level illustration of operations performed during efficient Montgomery multiplication, in accordance with at least some embodiments;

FIG. 4 is a flow diagram of an example method of efficient Montgomery multiplications with reduced interdependencies, in accordance with at least some embodiments;

FIG. 5 depicts a block diagram of an example computer system operating in accordance with some implementations of the present disclosure.

### DETAILED DESCRIPTION

Cryptographic applications often deploy asymmetric public/private key algorithms, e.g., DH, RSA, DSA algorithms. For example, a cryptographic application may generate a private/public keys by selecting a pair of large prime numbers, e.g., p and q, selecting a public (encryption) exponent e and then computing a secret (decryption) exponent d that is based on the public (encryption) exponent e and the selected numbers p and q. The numbers e and P=p·q may subsequently be revealed to other actors as part of the public key, while p, q, and d are stored (as the secret private key) by the recipient of future secret communications. A sender may encrypt a plaintext message m by computing a ciphertext message c using modular exponentiation, c=m^{e} mod P, and communicate c (e.g., publicly) to the recipient. The recipient may then decrypt the ciphertext by applying another modular exponentiation, m=c^{d} mod P. The original plaintext message is recovered provided that the value of the decryption exponent d is selected in such a way that e·d=1 modulo a suitably chosen number, e.g., (p−1)·(q−1).

Public/private key cryptography is a staple component of modern computer software and hardware systems, used in a multitude of applications, including confidential communications, time-stamping, non-repudiation protocols, cryptocurrency, and so on. In some systems, a cryptographic application may be instantiated during a system boot and used for secure data communications (e.g., between a processor and a system memory). RSA and other cryptographic applications involve a large number of modular multiplications, which amount to a standard multiplication followed by a modular reduction. To reduce the computational costs of modular reductions, computing algorithms often deploy the Montgomery reduction technique. More specifically, to compute ab mod P, the numbers a and B may first be transformed to the Montgomery domain, a→A=a·2^{r} mod P, and b→B=b·2^{R} mod P, where 2^{R} is an auxiliary modulus (Montgomery radix). Because of the presence of the extra factor 2^{R} in the product A·B=(a·b·2^{R})·2^{R} mod P, the number A·B is not equal to the Montgomery representation O of the product o=a·b mod P, as an extra division by 2^{R} has to be performed: O=A·B·2^{R} mod P. To compute A·B·2^{-R} mod P efficiently, a number K=−P⁻¹ mod 2^{R} that is a negative inverse of the modulus P is also selected; in other words, K·P+1=n·2^{R} with some integer n. An additional number Q=A·B·K mod 2^{R} may then be computed. Stated equivalently, the number Q obeys the relation, A·B+Q·P=O·2^{R} with some integer number O. The number Q is often referred to as a quotient, since it represents a quotient of the division of the product A·B by −P (with the number O·2^{R} being the remainder of such a division). By construction, it then follows that the number Q·P may be added to the product A·B without changing its value modulo P:

A·B mod P=[A·B+Q·P] mod P.

Because the sum A·B+Q·P is an integer of 2^{R}, it then follows that division of the sum A B+Q·P by 2^{R} is easily performed by right-shifting the sum by R bits, with the result yielding the Montgomery representation O of the product o=a·b mod P. (If the result exceeds P, the output O is obtained by one additional subtraction of P from O). In the Montgomery representation, any number of consecutive modular multiplications may be performed directly in the Montgomery domain (with only the final output O transferred back from the Montgomery domain to the standard domain, O→o).

Montgomery multiplications often involve large-sized numbers, e.g., numbers that are 512 bits long, 1028 bits long, and so on. Hardware multiplication circuits often can fit only a portion of a multiplicand and multiplier, the portion referred herein as a word. For example, each number A and B may be split into n words, e.g., A[n−1] . . . A[0], of m bits each: A=Σⱼ₌₀ⁿ⁻¹A[j]·2^{jm}. In a hardware accelerator having n² multiplications circuits capable of performing n² parallel word multiplications simultaneously, the Montgomery multiplication of A and B can take 3 rounds of parallel multiplications: 1) one round of n² word multiplications to compute various word products A[j]B[k] of T=A·B; 2) one round of n(n+1)/2 word multiplications to compute R least significant bits of the quotient Q=K·T, and 3) one round of n² word multiplications to compute various word products of Q·P. However, summation of the multiplication products may require a significant number of additional rounds. As a result of interdependencies caused by addition of carries, the Montgomery multiplication is extended over a substantial number of processing cycles. For example, summation of the word products of T=A·B and Q=K·T may each require n rounds of additions whereas the final summation T+Q·P may require 2n−1 rounds of additions. As a result, performance of the compete Montgomery multiplication may require 3 rounds of multiplications and 4n−1 rounds of additions. A hardware accelerator that is capable of performing any number of additions within a single processing cycle and one multiplication over two processing cycles can, therefore, take a total of 3×2+4n−1=4n+5 processing cycles.

Although various modifications of the Montgomery multiplication processing exist (including methods that use quotient computation pipelining), such techniques do not completely remove interdependencies between rounds of multiplications and additions and typically still require a large number of processing cycles.

Aspects and embodiments of the present disclosure address technological challenges by disclosing techniques and systems that are capable of a substantial acceleration of the Montgomery multiplications by reducing computational interdependencies. The improvement over the existing techniques may be achieved by precomputing a set of auxiliary numbers that are associated with the modulus P and the Montgomery radix 2^{R}, computing a set of quotients during a first set of computations, and using the computed quotients during a second stage of computations to efficiently compute the final output O=A·B·2^{-R} mod P. Operations with first n−4 words of a multiplier may take 2·(n−4) rounds of multiplications and n−4 of interspaced rounds of additions. Multiplications involving the remaining 4 words of the multiplier may take 4 rounds of multiplications. Additionally, 4 rounds of multiplications may be used to process multiplications of quotients. An additional multiplication circuit may be used to obtain a final quotient value in parallel with other multiplications. Most of the additions may be performed concurrently with the multiplications, with the exception of n final rounds of additions performed after all rounds of multiplications are completed. This amounts to the total of 2n rounds of multiplications and n rounds of additions. A hardware accelerator that performs additions within a single processing cycle and multiplications within two processing cycles may, therefore, take a total of 2×2n+n=5n processing cycles. An additional advantage of the disclosed techniques is that they may be supported by just n+1 multiplication circuits and ensure a high efficiency (utilization) of these circuits in the course of the Montgomery computations. For example, since the number of words is n=4, then 5 multiplication circuits are utilized over 8 processing cycles, 4 multiplication circuits are utilized over another 8 processing cycles, and no multiplication circuits utilized during the last 4 processing cycles, the average utilization of multiplication circuits is (5×8+4×8)/(5×20), or 72%.

The advantages of the disclosed devices and techniques include, but are not limited to, facilitation of fast and efficient Montgomery multiplication operations, a high hardware circuitry utilization rate, and an optimal number of multiplication circuits needed to perform the disclosed techniques.

### System Architecture

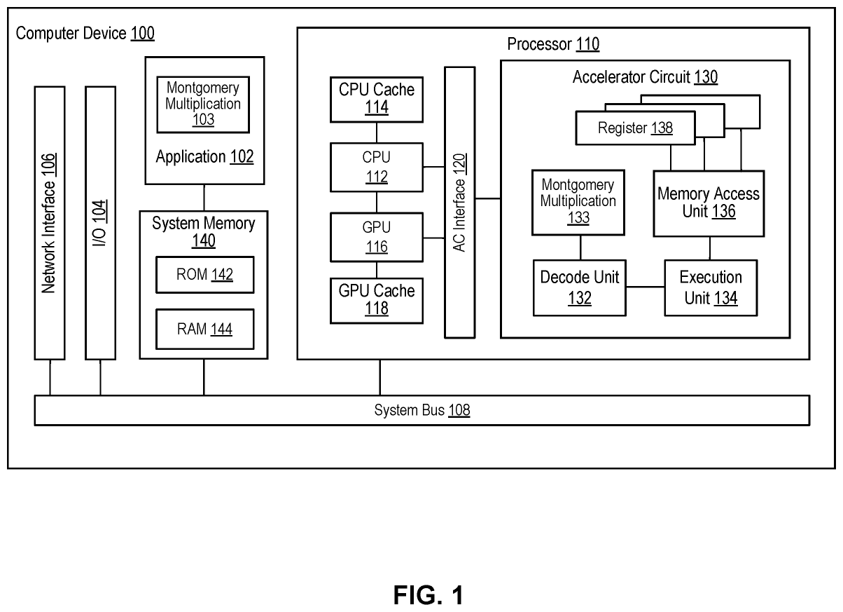

FIG. 1 is a block diagram of an example computer device 100 that performs efficient Montgomery multiplication with reduced interdependencies, in accordance with at least some embodiments. Example computer device 100 depicted in FIG. 1 may be a desktop computer, a tablet, a smartphone, a server (local or remote), a thin/lean client, a cloud computing node, a card reader, a wireless sensor node, an Internet-of-Things (IoT) node, an embedded system dedicated to one or more specific applications, and so on. One or more applications 102 may be executed on computer device 100.

Application(s) 102 supported by computer device 100 may include machine-learning application(s), graphics application(s), computational application(s), cryptographic application(s) (such as authentication, encryption, decryption, secure storage application(s), etc.), embedded application(s), external application(s), or any other types of application(s) that may be executed by computer device 100. Application(s) 102 may be instantiated on the same computer device 100, e.g., by an operating system executed by computer device 100. Alternatively, application(s) 102 may be external application(s) instantiated by a guest operating system supported by a virtual machine monitor (hypervisor) operating on the computer device 100. In some embodiments, the external application(s) may reside on a remote access client device or a remote server (not shown), with the computer device 100 providing cryptographic support for the client device and/or the remote server.

The computer device 100 may include one or more processors 110. “Processor” refers to any device capable of executing instructions encoding arithmetic, logical, or I/O operations. In one illustrative example, a processor may follow the Von Neumann architectural model. Processor 110 may include a central processing unit (CPU) 112, which may have any number of arithmetic logic units (ALUs), floating-point units (FPUs), control units, registers, and so on. CPU 112 may be executing at least some operations of application(s) 102. CPU 112 may include one or more cores having access to a single or multi-level cache 114. In some embodiments, each core may execute instructions to run a number of threads, also known as logical cores. Various logical cores may be assigned to one or more application(s) 102, although more than one logical core may be assigned to a specific application 102 for parallel processing. A multi-core CPU 112 may simultaneously execute multiple instructions. A single-core CPU 112 may typically execute one instruction at a time (or process a single pipeline of instructions). CPU 112 may be implemented as a single integrated circuit, two or more integrated circuits, or may be a component of a multi-chip module.

In some embodiments, some operations of application(s) 102 may be executed by one or more graphics processing units (GPUs) 116. GPU 116 may include multiple cores, each core being capable of executing multiple threads. Each core may run multiple threads concurrently (e.g., in parallel). In some embodiments, GPU threads may have access to thread-specific (private) GPU registers. Additionally, one or more shared GPU registers may be accessed by all threads of the GPU core. In at least one embodiment, each GPU core may include a scheduler to distribute computational tasks and processes among different GPU threads. GPU 116 may also have a dispatch unit to implement scheduled tasks on appropriate GPU threads using correct private and shared GPU registers. In some embodiments, GPU 116 may have a cache 118, access to which may be shared by multiple GPU cores. In some embodiments, CPU 112 may execute processes that involve serial computational tasks whereas GPU 116 may execute tasks that are amenable to parallel processing. In some embodiments, application(s) 102 may determine which processes are to be executed on GPU 116 and which processes are to be executed on CPU 112. In other embodiments, CPU 112 may determine which processes are to be executed on GPU 116 and which processes are to be executed on CPU 112. In some embodiments, processor 110 may include one or more application-specific integrated circuits (ASICs), field-programmable gate arrays (FPGAs), finite state machines (FSMs), and the like.

Processor 110 may have access, e.g., over a system bus 108, to one or more system memory 140 devices. System memory 140 may refer to any volatile or non-volatile memory and may include a read-only memory (ROM) 142, a random-access memory (RAM) 144, as well as (not shown) electrically erasable programmable read-only memory (EEPROM), flash memory, flip-flop memory, or any other device capable of storing data. RAM 144 may be a dynamic random-access memory (DRAM), synchronous DRAM (SDRAM), a static memory, such as static random-access memory (SRAM), and the like. In some implementations, processor 110 and the system memory 140 may be implemented as a single controller, e.g., as an FPGA.

Processor 110 may include an accelerator circuit 130 (accelerator co-processor, accelerator engine, etc.). One or more application(s) 102 may perform cryptographic operations on processor 110 with one or more functions, e.g., Montgomery multiplication function 103, being performed by accelerator circuit 130. Accelerator circuit 130 may include accelerator function units, e.g., Montgomery multiplication unit 133 to implement computations of Montgomery multiplication function 103 of application(s) 102, as described in more detail below. Accelerator circuit 130 may be communicatively coupled to CPU 112 and/or GPU 116 via accelerator circuit interface (AC interface) 120. In some embodiments, accelerator circuit 130 may perform a portion of cryptographic computations executed by processor 110. For example, CPU 112 (and/or GPU 116) may be executing an RSA algorithm while performing a number of Montgomery multiplications. In the course of performing a Montgomery multiplication for a specific modulus number P, CPU 112 (and/or GPU 116) may provide input numbers A and B to accelerator circuit 130. Additionally, the modulus number P as well as the Montgomery radix 2^{R} may be communicated to accelerator circuit 130 at the time of providing the input numbers or at some earlier time (e.g., during initialization of application(s) 102). In some embodiments, after receiving the modulus number P and the Montgomery radix 2^{R}, accelerator circuit 130 may precompute one or more auxiliary numbers, as described in more detail below, that facilitate removing dependencies between various rounds of computational operations (e.g., multiplications and/or additions) during computation of the Montgomery multiplication. In some embodiments, CPU 112 (and/or GPU 116) precomputes the one or more auxiliary numbers and stores the precomputed auxiliary numbers in registers 138 of accelerator circuit 130, whereas and accelerator circuit 130 is a dedicated engine that computes the output value 0=(A·B)·2^{-R} mod P and returns the computed output value to CPU 112 (and/or GPU 116). In some embodiments, the accelerator circuit may be capable of performing other operations, in addition to the Montgomery multiplication.

Accelerator circuit 130 may include a decode unit 132 (also known as a decoder), which may be coupled to an instruction fetch unit (not depicted in FIG. 1). Decode unit 132 may decode instructions, and generate one or more micro-operations, micro-code entry points, microinstructions, other instructions, or other control signals, which are decoded from, or which otherwise reflect, or are derived from, the original instructions. Decode unit 132 may be implemented using various mechanisms, e.g., look-up tables, hardware implementations, programmable logic arrays (PLAs), microcode read only memories (ROMs), and the like.

Decode unit 132 may be coupled to an execution unit 134, which may include a scheduler unit (not depicted in FIG. 1). Decode unit 132 and execution unit 134 may be coupled to one or more registers 138 via a memory access unit 136. Each register 138 may store one or more different data types, such as scalar integer, scalar floating point, packed integer, packed floating point, vector integer, vector floating point, etc., status (e.g., an instruction pointer that is the address of the next instruction to be executed), etc.

In some embodiments, decode unit 132 may receive instructions from CPU 112 (and/or GPU 116) that may include an identification of the operation to be performed (e.g., the Montgomery multiplication) together with the input values (e.g., A and B). Decode unit 132 may store the received input values in registers 138. Decode unit 132 may store (or access previously stored) auxiliary numbers, as described in more detail below. Decode unit 132 may then use a decoding circuitry to determine one or more operations to be performed on the input value by execution unit 134, such as addition operations, division (e.g., bit-shifting) operations, and the like. During execution of the operations by execution unit 134, intermediate values may be stored in registers 138. After the completion of the Montgomery multiplication computations, the final output may be moved to CPU cache 114 (or GPU cache 118). In some embodiments, after completion of the computations, memory access unit 136 may provide to CPU 112 (or GPU 116) an identification of a register 138 storing the final output and CPU 112 (or GPU 116) may fetch the final result directly from the corresponding register.

The computer device 100 may further include an input/output (I/O) component 104 to facilitate connection of computer device 100 to various peripheral hardware devices (not shown) such as card readers, terminals, printers, scanners, IoT devices, and the like. Computer device 100 may further include a network interface 106 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from computer device 100.

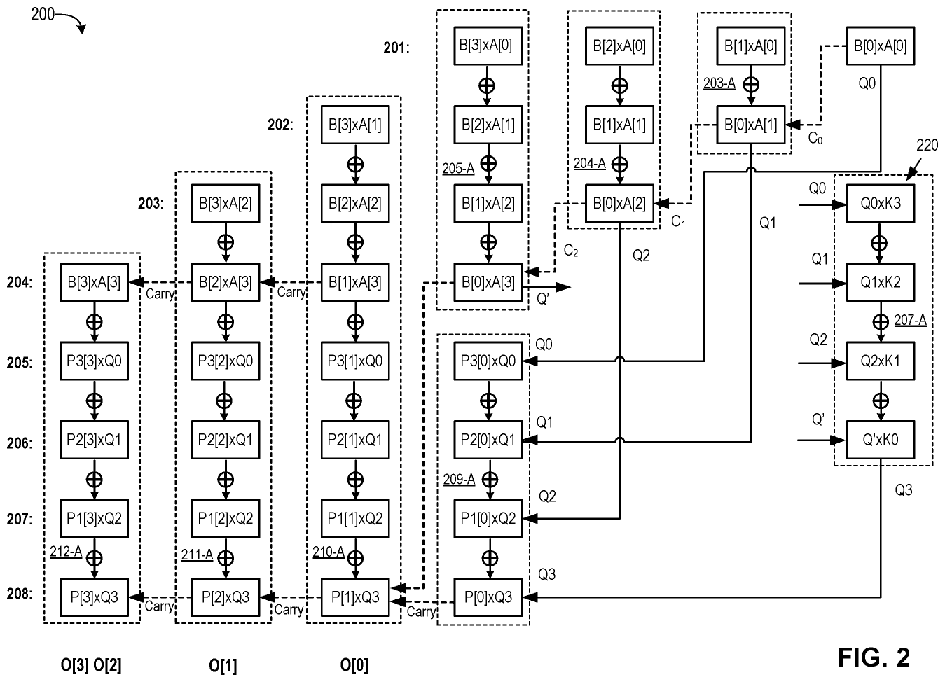

FIG. 2 illustrates an example data flow 200 in the course of performance of efficient Montgomery multiplication with reduced interdependencies, in accordance with at least some embodiments. Example data flow 200 is illustrated using the Montgomery multiplication·B·2^{-R} mod P, in which the multiplier A and the multiplicand B are represented with n=4 words, but it should be understood that input multipliers and multiplicands with any number of words n may be handled in a similar manner. In some embodiments, example operations 200 may be implemented by various units of accelerator circuit 130. In some implementations, example operations 200 may be implemented by a combination of CPU 112 (GPU 116) and accelerator circuit 130, by a combination of accelerator circuit 130 and a software executed by CPU 112 (GPU 116), or purely by software executed by CPU 112 (GPU 116). More specifically, to perform the Montgomery multiplication A·B·2^{-R} mod P, various auxiliary numbers may be precomputed and stored in the memory of the processing device performing the computations. The auxiliary numbers may be computed based on the modulus P and the Montgomery mini-radix 2^{r}, where r=R/n. (Throughout this disclosure, both the full Montgomery radix 2^{R} and the Montgomery mini-radix 2^{r} are referred to as “Montgomery radix” for conciseness.) For example, a number that is a negative inverse of the modulus with respect to the Montgomery radix may be computed,

K0=−P⁻¹ mod 2^{r},

similarly to the conventional Montgomery multiplication. In addition, the (negative) inverses of the modulus with respect to modified Montgomery radixes (e.g., a square and a cube of the Montgomery radix 2^{r}) may similarly be computed:

H2=−P⁻¹ mod 2^{2r},

H3=−P⁻¹ mod 2^{3r}.

By construction, the computed numbers K0, H2, and H3 multiplied by the modulus and incremented by 1 are divisible by the corresponding radixes. For example, K0·P+1 is divisible by 2^{r}, H2·P+1 is divisible by 2^{2r}, and H3·P+1 is divisible by 2^{3r}. The quotients of the respective division operations may be computed and stored as a first set of auxiliary numbers:

P1=(K0·P+1)/2^{r},

P2=(H2·P+1)/2^{2r}.

P3=(H3·P+1)/2^{3r}.

Furthermore, a second set of auxiliary numbers, which are modular products of each of the first set of auxiliary numbers and the (negative) inverse modulus K0, may be computed and stored:

K1=P1·K0 mod 2^{r},

K2=P2·K0 mod 2^{r}.

K3=P3·K0 mod 2^{r}.

The number K0 may also be stored as part of the second set of auxiliary numbers. In some embodiments, the numbers H2 and H3 are stored temporarily and then overwritten with numbers of the second set, e.g., K1, K2 and/or K3

The auxiliary numbers, precomputed and stored, may then be used during computations of the Montgomery product of input numbers A and B. The input numbers may be stored in input registers of the accelerator circuit or any other memory device. Different words of the input multiplier A (or input multiplicand B) may be processed concurrently by different multiplication circuits. For example, during a first round of n multiplications 201 (the top row of multiplication boxes in FIG. 2), n multiplication circuits may compute n multiplication products of the first (least significant) word of the multiplier A[0] by each of the n words B[n−1] . . . B[0] of the multiplicand. As a result, n two-word products B[j]×A[0] are computed during the first round of multiplications 201. (Throughout this disclosure, multiplication operations are denoted with either a cross symbol “x” or a dot symbol “·” interchangeably.) The least significant word of each product Sⱼ=B[j]×A[0] may be stored (e.g., in an accumulator register) as an accumulator value and the high word of the same product B[0]×A[0] may be stored (e.g., in a scratch buffer) as a carry value. For example, the first round of multiplications 201 computes S₀=B[0]×A[0], stores the least significant word Q0=S₀ mod 2^{r} as a first quotient value, and also stores the high word, C₀=S₀ »r as a carry value into the second word of the product A·B.

The second round of multiplications 202 (the second row of multiplication boxes in FIG. 2) may be performed similarly, with n multiplication circuits computing n multiplication products of the second word of the multiplier A[1] with each of the n words B[n−1] . . . B[0] of the multiplicand. As a result, n two-word products B[k]×A[1] are computed during the second round of multiplications 202. These products are used to update the values Sⱼ (with j≥1) computed during the first round of multiplications 201. For example, the least significant word of the updated value S₁=S₁+B[0]×A[1] determines the second least significant word of the product A·B and is stored as a second quotient value Q1=S₁ mod 2^{r}. The high word of the value C₁=S₁»r is stored in the scratch buffer as a carry value into the third word of the product A·B. The existing values S₂ and S₃ may similarly be updated with the products B[1]×A[1] and B[2]×A[1], respectively, and a new value S₄ is computed as B[3]×A[1]. The updates of the values Sⱼ may be performed immediately or may be delayed until all addends are available, as described in more detail below.

The third round of multiplications 203 may be performed using n+1 multiplication circuits. More specifically, n multiplication circuits may compute n multiplication products of the third word of the multiplier A[2] with each of the n words B[n−1] . . . B[0] of the multiplicand. As a result, n two-word products B[j]×A[2] are computed during the third round of multiplications 203. These products are used to update the values Sⱼ (with j≥2) computed during the previous rounds of multiplications. For example, the least significant word of the updated value S₂=S₂+B[0]×A[2] determines the second least significant word of the product A·B and is stored as a third quotient value Q2=S₂ mod 2^{r}. The high word of the value C₂=S₂»r may be stored in the scratch buffer as a carry value into the fourth word of the product A·B. The values S₃ and S₄ may similarly be updated with the products B[1]×A[2] and B[2]×A[2], respectively, and new value S₅ is started as B[3]×A[2].

Additionally, the third round of multiplications 203 may be used to begin accumulation of the final quotient value 4=(Q0×K3+Q1×K2+Q2×K1+Q′×K0) mod 2^{r}, as depicted with column 220 in FIG. 2. More specifically, during the third round of multiplications, an n+1-th multiplication circuit may compute the least significant word of the product Q0×K3 using the first quotient Q0 and auxiliary number K3.

The fourth round of multiplications 204 may similarly be performed using n+1 multiplication circuits. More specifically, n multiplication circuits may compute n multiplication products of the fourth word of the multiplier A[3] with each of the n words B[n−1] . . . B[0] of the multiplicand. As a result, n two-word products B[j]×A[3] are computed during the fourth round of multiplications 204. These products are used to update the values Sⱼ (with j≥3) computed during the previous rounds of multiplications. For example, the least significant word of the updated value S₃=S₃+B[0]×A[3] determines the second least significant word of the product A·B and is stored as a fourth quotient value Q′=S₃ mod 2^{r}. The high word of the value C₃=S₃»r may be stored in the scratch buffer as a carry value into subsequent rounds of computations. The values S₄ and S₅ may similarly be updated with the products B[1]×A[3] and B[2]×A[3], respectively, and new value S₆ is started as B[3]×A[3]. Additionally, the fourth round of multiplications 204 may involve the n+1-th multiplication circuit computing the least significant word of the product Q1×K2 as another contribution into the final quotient value Q3.

Dashed boxes in FIG. 2 indicate addition operations that involve products of the multiplication operations. The numerals in each dashed box correspond to the respective rounds of multiplication operations during which the addition operations of the box may be completed. In some embodiments, all addition operations inside the respective box may be performed during a single round of multiplication operations. For example, the addition operations of box 204-A may be performed during the fourth round of multiplications 204 so that the output of the addition operations of box 204-A (quotient value Q2) is determined prior to the fifth round of multiplications 205 (where quotient value Q2 is used to compute Q2×K1). More specifically, each of the adders B[2]×A[0], B[1]×A[1], and B[0]×A[2] may be computed during the respective round of multiplication operations and stored until the last adder (e.g., B[0]×A[2]) is ready; all adders are then added during a single addition operation. Such processing may be used in the embodiments that deploy addition circuits capable of accepting multiple operands at a time (e.g., during a single cycle).

In some embodiments, the addition operations inside each dashed box are performed in a pipelined fashion using an accumulation register. For example, the operands B[2]×A[0] and B[1]×A[1] may be added during the third round of multiplication operations 203 and stored in the accumulation register. During the fourth round of multiplication operations 204 the next operand B[0]×A[2] may be added to the value stored in the accumulation register. Such processing may be used in the embodiments that deploy addition circuits capable of accepting two operands at a time. Such processing may also be used to reduce the amount of memory that stores various intermediate multiplication products B[j]×A[k].

The fifth round of multiplications 205 may also be performed using n+1 multiplication circuits. More specifically, during the fifth round of multiplications 205, n multiplication circuits may begin computing multiplication products of auxiliary numbers P3, P2, P1, and modulus P, and the quotient values Q0, Q1, Q2, and Q3. For example, each of the n words P3 [n−1] . . . P[0] of the auxiliary number P3 may be multiplied by (a single-word) quotient value Q0 computed during the third round of multiplications. Additionally, during the fifth round of multiplications 205, the n+1-th multiplication circuit may compute the least significant word of the product Q2×K1 as another contribution into the final quotient value Q3.

Similarly, during the sixth (seventh) round of multiplications 206 (207), each of the n words of the auxiliary number P2 (P1) may be multiplied by a single-word quotient value Q1 (Q2) computed during the fourth (fifth) round of multiplications. Additionally, during the sixth round of multiplications 206, the n+1-th multiplication circuit may compute the least significant word of the product Q′×K0 as another contribution into the final quotient value Q3. During the seventh round of multiplications 207, the addition circuit may obtain the final quotient value Q3 by computing the least significant word of the sum 0×K3+Q1×K2+Q2×K1+Q′×K0. In some embodiments, this sum may be computed using an accumulator register for the final quotient value, computing sequentially, Q3=(0+Q0×K3) mod 2^{r} (during the fourth round of multiplications 204), Q3=(Q3+Q1×K2) mod 2^{r} (during the fifth round of multiplications 205), Q3=(Q3+Q2×K1) mod 2^{r} (during the sixth round of multiplications 206), and Q3=(Q3+Q′×K0) mod 2^{r} (during the seventh round of multiplications 207).

During the final (eighth) round of multiplications 208, each of the n words of the auxiliary number P may be multiplied by the single-word final quotient value Q3. As a result, the Montgomery multiplication product of the first number and the second number is obtained using 2n sets of concurrent multiplication operations, each of the 2n sets including n or n+1 concurrent multiplication operations.

During the next round, addition operations of box 209-A may be performed with the sum of n contributions, as listed in box 209-A. All bits of the least significant word of the sum may be zero by construction and may be discarded whereas the high word of the sum may be passed as a carry value into addition operations of box 210-A. During addition operations of box 210-A, the numbers listed in box 210-A may be added. The least significant word of the sum of box 210-A numbers may be stored as the first word of the output O[0] whereas the high word of the sum may be passed as a carry value into addition operations of box 211-A. During addition operations of box 211-A, the numbers listed in box 211-A may be added. The least significant word of the sum of box 211-A numbers may be stored as the second word of the output O[1] whereas the high word of the sum may be passed as a carry value into addition operations of box 212-A. During the final addition operations of box 212-A, the least significant word of the sum of box 212-A numbers may be stored as the third word of the output O[2] whereas the high word of the sum may be stored as the last word of the output O[3].

In some other embodiments, the number of words n of the multiplicand and the multiplier may be greater than four. In such embodiments, each of the modulus P, and the auxiliary numbers of the first set of auxiliary numbers, e.g., P1, P2, and P3, may also be numbers with n>4 words. In such embodiments, the four rounds of multiplications 201-204 may involve the last four words of the multiplier, e.g., the first round of multiplications 201 may involve multiplications of words of multiplicand B by the word A[n−4] of the multiplier, the second round of multiplications 202 may involve multiplications of words of multiplicand B by the word A[n−3], the third round of multiplications 203 may involve multiplications of words of multiplicand B by the word A[n−2], and the fourth round of multiplications 204 may involve multiplications of words of multiplicand B by the word A[n−1]. Additionally, prior to performing the four rounds of multiplications 201-204, the processing device that computes Montgomery multiplication in accordance with the disclosed techniques may perform n−4 preliminary rounds of computations. For example, the first preliminary round computes a value S=B×A[0] using the first word of the multiplier. The second preliminary round:
(1) computes a quotient value q as the least significant word of the sum q=S mod 2^{r};
(2) adds the high word (carry) of S to the new product computed with the next word of the multiplier: S=S»r+B×A[1]; and
(3) updates the value S using the computed quotient: S=S+P1×q.
   The rest of the preliminary rounds may repeat operations (1)-(3) until the remaining words A[2]αA[n−5], are processed, each round updating the quotient value q and multiplying the updated quotient value by P1 to update the value S.

The following operations may be performed to compute an output of Montgomery multiplication product for an arbitrary n≥4 number of words.

TABLE 1
Efficient Montgomery multiplication

| | Input: |
|---|---|
| | P; K0 = −P⁻¹mod 2^{r}; H2 = −P⁻¹mod 2^{2r}; |
| | H3 = −P⁻¹mod 2^{3r}; P3 = (H3 · P + 1)/2^{3r}; |
| | P2 = (H2 · P + 1)/2^{2r}; P1 = (K0 · P + 1)/2^{r} |
| | K3 = P3 · K0 mod 2^{r}; K2 = P2 · K0 mod 2^{r}; |
| | K1 = P1 · K0 mod 2^{r}; A, B < 2³ × P |
| | Output: O = (AB) × 2−^{nr} mod P |
| 1 | S := 0; q := 0; |
| 2 | for i:=0 to n-4 do |
| 3 | q := S mod 2^{r}; S := (S >> r) + A[i] × B; |
| 4 | S := S + q × P1; |
| 5 | end |
| 6 | Q0 := S mod 2^{r}; S : = (S >> r) + A[n − 3] × B; |
| 7 | Q1 := S mod 2^{r}; S : = (S >> r) + |
| | A[n − 2] × B; Q3 = Q0 × K3 mod 2^{r}; |
| 8 | Q2 := S mod 2^{r}; S : = (S >> r) + |
| | A[n − 1] × B; Q3 := (Q3 + Q1 × K2) mod 2^{r}; |
| 9 | Q′ := S mod 2^{r}; S : = S + Q0 × P3; |
| | Q3 := (Q3 + Q2 × K1) mod 2^{r}; |
| 10 | S : = S + Q1 × P2; Q3 := (Q3 + Q′ × K0) mod 2^{r}; |
| 11 | S : = S + Q2 × P1; Q3 := Q3 mod 2^{r}; |
| 12 | S : = (S + Q3 × P) >> r; |
| 13 | return S → O; |

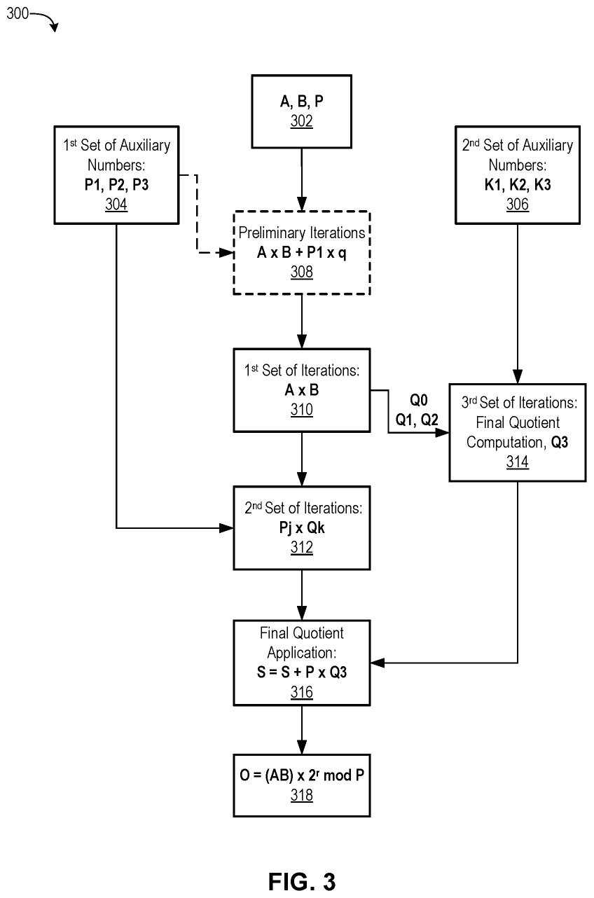

Various operations listed in TABLE 1 are further illustrated below in conjunction to FIG. 3.

The embodiments described above in conjunction with TABLE 1 involve precomputing the first set of auxiliary numbers consisting of three numbers, e.g., P1, P2, and P3, and computing 4 quotient values, e.g., Q0, Q1, Q2, and Q3. The embodiments described include n−4 preliminary rounds in which the first n−4 words of multiplier (e.g., A[0], A[1] . . . A[n−5]) are multiplied by the multiplicand B and preliminary quotient values q are computed and then used in computing the running value S (the quotients Q0, Q1, Q2 that are multiplied by P1, P2, and P3, as well as the final quotient Q3) are computed during the last 4 rounds of multiplication of A[n−4], A[n−3], A[n−2], and A[n−1] by the multiplicand B.

In some embodiments, instead of performing the preliminary rounds, each of n rounds of multiplications can be used to computed one of the quotient values Q0, Q1 Q(n−1) that are later to be used with a respective one of the first set of auxiliary numbers P(n−1), P(n−2), . . . P1 (with the exception of the final quotient value Q(n−1) that is multiplied by the modulus P). As described below, such embodiments can be used for the number of words n of the multiplier A and the multiplicand B that is any integer number larger than one, n≥2. In such embodiments, each of the modulus P, and the auxiliary numbers P(j) may also be numbers with n words. In such embodiments, the four rounds of multiplications 201-204 may be adjusted (expanded or reduced) to include n rounds of multiplications. The first round of multiplications 201 may involve multiplications of words of multiplicand B by the word A[0] of the multiplier, the second round of multiplications 202 may involve multiplications of the words of multiplicand B by the word A[1] of the multiplier, and so on, and the n-th round of multiplications may involve multiplications of the words of multiplicand B by the word A[n−1] of the multiplier. Similarly, the four rounds of multiplications 205-208 may be adjusted (expanded or reduced) to include n rounds of multiplications. More specifically, the round of multiplications 205 may involve multiplications of the quotient value Q0 by each of n words of the auxiliary number P(n−1), e.g., Q0×P(n−1). The next round of multiplications 206 may involve multiplications of words of the next quotient value Q1 by each of n words of the auxiliary number P(n−2), e.g., Q1×P(n−2), and so on. The last round of multiplications may involve multiplications of the final quotient value Q (n−1) by each of n words of the modulus P, e.g., Q(n−1)×P. TABLE 2 below illustrates one example embodiment of the Montgomery multiplication product for an arbitrary n≥2 number of words that uses no auxiliary numbers and performs no rounds of preliminary computations.

TABLE 2
Another embodiment of the efficient
Montgomery multiplication

| | Input: |
|---|---|
| | P; K0 = −P⁻¹mod 2^{r}; H2 = −P⁻¹mod 2^{2r}; ... |
| | H(n − 1) = −P⁻¹mod 2^{(n - 1)·r}; |
| | P(n − 1) = (H(n − 1) · P + 1)/2^{(n - 1)·r}; ... |
| | P2 = (H2 · P + 1)/2^{2r}; P1 = (K0 · P + 1)/2^{r} |
| | K(n − 1) = P(n − 1) · K0 mod 2^{r}; ... K2 = |
| | P2 · K0 mod 2^{r}; K1 = P1 · K0 mod 2r; |
| | A, B <2³ × P |
| | Output: O = (AB) × 2^{-nr}mod P |
| 1 | S := 0; Q(−1): = 0; Q′ = 0; |
| 2 | for i:=0 to n-1 do |
| 3 | S := (S >> r) + A[i] × B; Q(i) := S mod 2^{r}; |
| | Q′ := (Q′ + Q(i − 1) × K(n − i)) mod 2^{r} |
| 4 | end |
| 5 | Q(n − 1): = (Q′ + Q(n − 1) × K0) mod 2^{r}; |
| 6 | for i:=0 to n-2 do |
| 7 | S : = S + Q(i) × P(n − 1 − i); |
| 8 | end |
| 9 | S : = (S + Q(n − 1) × P) >> r; |
| 10 | return S → O; |

FIG. 3 is a high-level illustration of operations 300 performed during efficient Montgomery multiplication, in accordance with at least some embodiments. In some embodiments, operations 300 may be used to compute the Montgomery multiplication product of a first number (e.g., A) and a second number (e.g., B). Operations 300 may be performed by an accelerator circuit that includes a plurality of multiplication circuits, e.g., four multiplication circuits, or any other number n of multiplication circuits equal to a number of words of the input (and auxiliary) numbers. The plurality of multiplication circuits may be used to compute the product of the first number and the second number, as well as other multiplication products. The accelerator circuit may further include an additional multiplication circuit, e.g., n+1-th multiplication circuit. In some embodiments, the plurality of multiplication circuits contains four multiplication circuits and the additional multiplication circuit is the fifth multiplication circuit. The additional multiplication circuit may be used to compute products of quotients and at least some auxiliary numbers, as well as other multiplication products. The accelerator circuit may include one or more registers to store a first set of auxiliary numbers (e.g., P1, P2, P3) and a second set of auxiliary numbers (e.g., K1, K2, K3). Each auxiliary number of the first set of auxiliary numbers and each auxiliary number of the second set of auxiliary numbers may be associated with a modulus number (e.g., P) and a Montgomery radix value (e.g., 2^{r}), as described above in conjunction with FIG. 2. The accelerator circuit may further include one or more addition circuits to perform addition of various computed multiplication products. Addition circuits, as used herein, should be understood as also including various bit shifters (e.g., shift registers) that can be used to split numbers into words, eliminate least (most) significant bits (words) of numbers, and so on.

The input 302 into the efficient Montgomery multiplication may include multiplier A, multiplicand B, modulus P, and Montgomery radix 2^{r}. A first set of auxiliary numbers 304 (e.g., P1, P2, and P3) and a second set of auxiliary numbers 306 (e.g., K1, K2, and K3) may be precomputed and stored in the memory, e.g., one or more registers, of the accelerator circuit that performs the Montgomery multiplication. In some embodiments, a first plurality of iterations 310 may be used to process the of words of the first number and the second number to obtain a set of quotient values (e.g., Q0, Q1, and Q2), as described above and further specified in entries 6-8 of TABLE 1. More specifically, the plurality of multiplication circuits may compute a first set of multiplication products that includes multiplication products of each word of a first number with each word of a second number (e.g., B[k]×A[j]). The one or more addition circuits may then determine, using on the first set of multiplication products, the set of quotient values.

In the instances where the processor (or accelerator circuit) of the computing device is configured to process multiplication of words that are smaller than a quarter size of the input numbers A and B, the input numbers may be represented via n>4 words. In such instances, a plurality of preliminary iterations 308 may be performed using n−4 words of the multiplier A (or, alternatively, multiplicand B), auxiliary number P1 and preliminary quotient q, e.g., as described above and further specified in entries 2-5 of TABLE 1.

The quotient values may be used in conjunction with auxiliary numbers during a second set of iterations 312. The second set of iterations 312 is illustrated in entries 9-11 of TABLE 1. More specifically, the plurality of multiplication circuits may be used to compute a second set of multiplication products that include multiplication products of each quotient value of the set of quotient values (e.g., Q0, Q1, and Q2) and each word of a corresponding auxiliary number (e.g., P3, P2, and P1) of the first set of auxiliary numbers. For example, during a first iteration of the second set of iterations 312, the plurality of multiplication circuits may compute multiplication products of quotient value Q0 and each word of auxiliary number P3, during a second iteration of the second set of iterations 312, the plurality of multiplication circuits may compute multiplication products of quotient value Q1 and each word of auxiliary number P2, etc.

Additionally, a final quotient Q3 may be determined during a third set of iterations 314 using the quotient values in conjunction with the second set of auxiliary numbers. The third set of iterations may be performed as described above and further specified in entries 7-11 of TABLE 1. More specifically, the additional multiplication circuit may be used to compute a third set of multiplication products that includes multiplication products of each quotient value of the set of quotient values (e.g., Q0, Q1, and Q2) and a corresponding auxiliary number of the second set of auxiliary numbers (e.g., K3, K2, and K1). The one or more addition circuits may then be used to determine, using the third set of multiplication products, a final quotient value, e.g., by computing the sum of the products of quotient values and a corresponding auxiliary numbers, Q0×K3+Q1×K2+Q2×K1 (as well as adding another contribution, Q′×K0, as described above in conjunction with FIG. 2).

The final quotient Q3 may then be used together with modulus P in a final quotient application 316 (illustrated in entry 12 of TABLE 1) to produce the output O (318) of the Montgomery multiplication, e.g., the product of the first number and the second number. More specifically, the plurality of multiplication circuits may be used to compute a fourth set of multiplication products that includes multiplication products of the final quotient value Q3 and each word of the modulus number P (e.g., P[k]×Q3). The one or more addition circuits may then be used to obtain, using the third set of multiplication products and a fourth set of multiplication products (as well as some of the first set of multiplication products, as illustrated with boxes 210-A, 211-A, and 212-A) the output of the Montgomery multiplication.

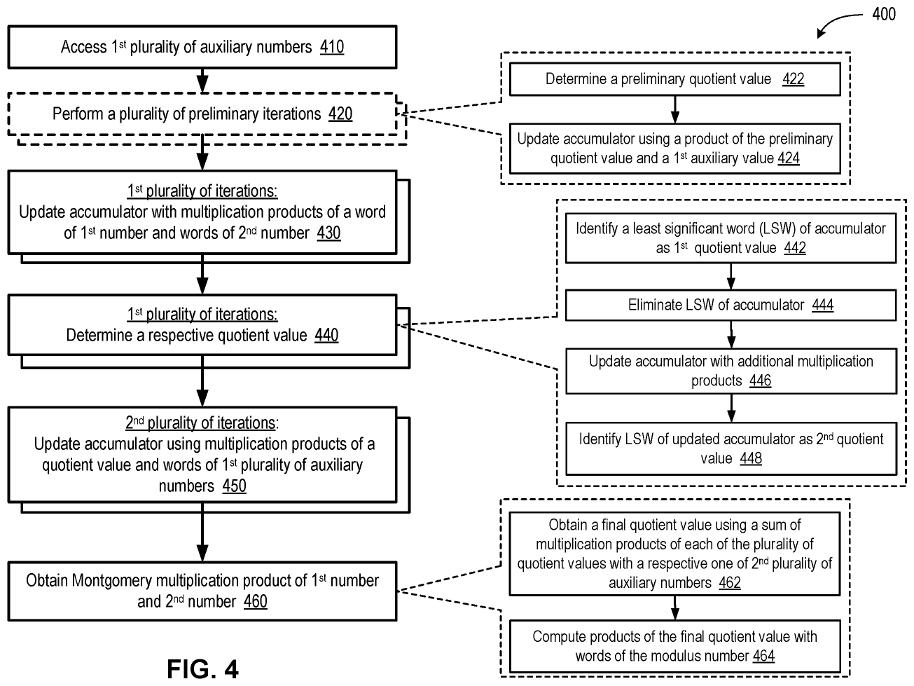

FIG. 4 is a flow diagram of an example method 400 of efficient Montgomery multiplications with reduced interdependencies, in accordance with at least some embodiments. In some embodiments, method 400 may be performed by processing units of accelerator circuit 130 of FIG. 1 that may include (or communicate with) one or more memory device (e.g., registers). In some embodiments, method 400 may be performed by a cryptographic engine configured to perform public/private key cryptographic computations, or by a general-purpose CPU (or GPU). Processing units that perform method 400 may include decode unit 132, execution unit 134, memory access unit 136, and other units of accelerator circuit 130 (e.g., fetch unit, scheduler unit, etc.). In some embodiments, method 400 may be performed responsive to instructions from CPU 112 (or GPU 116). In some embodiments, method 400 may be executed by one or more processing threads, each thread executing one or more individual functions, routines, subroutines, or operations of the method. In some embodiments, processing threads implementing method 400 may be synchronized (e.g., using semaphores, critical sections, and/or other thread synchronization mechanisms). Alternatively, processing threads implementing method 400 may be executed asynchronously with respect to each other. Various operations of method 400 may be performed in a different order compared with the order shown in FIG. 4. Some operations of method 400 may be performed concurrently with other operations. In some embodiments, one or more operations shown in FIG. 4 may be optional.

In some embodiments, method 400 may be used to compute a Montgomery multiplication product, modulo a modulus number (e.g., P), of a first number (e.g., A), and a second number (e.g., B). In some embodiments, method 400 may include accessing, at block 410, a first plurality of auxiliary numbers associated with the modulus number and a Montgomery radix value (e.g., 2^{r}). For example, the first plurality of auxiliary numbers may include numbers P1, P2, P3, which may be computed as described above, e.g., P1=(K0·P+1)/2^{r}, P2=(H2·P+1)/2^{2r}, P3=(H3·P+1)/2^{3r}, where K0 is a negative inverse of the modulus P modulo 2^{r}, H2 is a negative inverse of the modulus modulo radix squared, 2^{2r}, and H3 is a negative inverse of the modulus modulo radix cubed, 2^{3r}. In some embodiments, the first plurality of auxiliary numbers may be precomputed before the first number and/or the second number are identified, e.g., precomputed and stored once for multiple encoding and decoding operations using a previously established public/private key pair. In some implementations, the first plurality of auxiliary numbers may be computed at run-time as part of method 400.

In some embodiments, various numbers (e.g., multiplier A, multiplicand B, the modulus, auxiliary numbers, etc.) may be represented via n words. For example, a 256-bit first number (e.g., multiplier A) and second number (e.g., multiplicand B) may be represented via four 64-bit words each whereas 512-numbers may be represented via eight 64-bit words each. In some embodiments, where the number of words of the first (second) number of word n is greater than four, method 400 may include performing, at optional block 420 (indicated with the bashed boxes), a plurality of preliminary iterations to process the first n−4 words of the multiplier. For example, as indicated with the top callout portion in FIG. 4, each of the plurality of preliminary iterations may include determining, at block 422, a preliminary quotient value (e.g., q) based on an accumulator (e.g., S). In some embodiments, block 422 may include operations of entry 3 in TABLE 1. At block 424, the preliminary iterations may include updating the accumulator using a multiplication product of the preliminary quotient value (e.g., q) with a first auxiliary number (e.g., P1) of the first plurality of auxiliary numbers. In some embodiments, block 422 may include operations of entry 4 in TABLE 1.

At blocks 430-440 method 400 may include the processing units performing a first plurality of iterations, which may include rounds of multiplications 201-204, as depicted in FIG. 2. As depicted by block 430, each of the first plurality of iterations may include updating accumulator S with multiplication products (e.g., B[k]×A[j]) of a respective word of a plurality of words of the first number (e.g., A[j]) with each of a plurality of words of the second number (e.g., B[k]). For example, a first iteration of the first plurality of iterations may include multiplying A[0] (if n=4) or A[n−4] (if n>4) by each of B[0] . . . B[n−1]. The accumulator S should be understood as any collection of numbers that include or represent multiplication products B[k]×A[j] and/or any other numbers that are generated based on the words of the first number A[j] and second number B[k], which may include i) multiplication products of the words of the first number A[j] and second number B[k], ii) multiplication products of quotients Q0, Q1, Q2 (obtained using the words the first number A[j] and second number B[k]) and the words of the first plurality of auxiliary numbers (e.g., P3, P2, P1) obtained as part of the second plurality of iterations (as described in more detail below in conjunction with block 450), iv) multiplication products of the final quotient Q3 and the words of the modulus P, and so on. The accumulator S should be further understood as any representations of such or similar multiplication products, including multiplication products B[k]×A[j], P3[k]×Q0, P2[k]×Q1, etc., stored as separate numbers within one or more registers or other memory devices, or in any partially summed (aggregated) form, reduced form (e.g., with one or more words eliminated by right-shifting, etc.). For example, after completion of m iterations (e.g., of the plurality of preliminary iterations, the first plurality of iterations, and/or the second plurality of iterations, etc.), the accumulator may include m×n individual (e.g., two-word) values of the computed multiplication products. In some embodiments, after completion of m iterations, the accumulator may include m+n partially summed (aggregated) values (e.g., summed along the columns, as indicated in FIG. 2). In some embodiments, after completion of m iterations, the accumulator may include only n partially summed (aggregated) values with m values eliminated (e.g., right-shifted) or stored as quotients or other numbers. In some embodiments, the accumulator may further include any number of carries, which may be stored individually, in associations with the corresponding partial sums (e.g., of columns of FIG. 4), or aggregated into the corresponding partial sums.

At block 440, method 400 may include determining, based on the updated accumulator, a respective quotient value of a plurality of quotient values. In some embodiments, updating the accumulator and determining the quotient values may be performed as depicted in the middle callout portion of FIG. 4. For example, as illustrated by block 442, the processing units performing method 400 may determine a first quotient value (e.g., Q0) of the plurality of quotient values by identifying a least significant word of the accumulator (e.g., of the product B[0]×A[0]), as the first quotient value. To determine a second quotient value (e.g., Q1) of the plurality of quotient values, the processing units may eliminate, al block 444, the least significant word of the accumulator (e.g., the already determined value Q0). For example, the elimination of the least significant word may be performed by right-shifting the accumulator by one word. At block 446, determining the second quotient value may include updating the accumulator with additional multiplication products, e.g., products B[1]×A[0] and B[0]×A[1]. In some instances, updating the accumulator may include adding to the accumulator the most significant word of the product B[0]×A[0] (e.g., the carry word). At block 448, the processing units performing method 400 may identify a least significant word of the updated accumulator as the second quotient value (e.g., Q1).

At block 450, method 400 may continue with the processing units performing a second plurality of iterations, which may include rounds of multiplications 205-207, as depicted in FIG. 2. Each of the second plurality of iterations may include updating the accumulator using multiplication products of a quotient value of the plurality of quotient values (e.g., Q0, Q1, Q2). with each of a plurality of words of a respective auxiliary number of the first plurality of auxiliary numbers (e.g., P3, P2, P1).

At block 460, the processing units performing method 400 may obtain the Montgomery multiplication product of the first number and the second number using the updated accumulator. More specifically, the processing units performing method 400 may access a second plurality of auxiliary numbers (e.g., K3, K2, K1) associated with the modulus number. As depicted with the bottom callout portion of FIG. 4, operations of block 460 may include obtaining, at block 462, a final quotient value (e.g., Q3) using a sum of multiplication products (e.g., Q0×K3, Q1×K2, Q2×K1) of each quotient value of the plurality of quotient values (e.g., Q0, Q1, Q2) with a respective auxiliary number of the second plurality of auxiliary numbers (e.g., K3, K2, K1). Each of the second plurality of auxiliary numbers (e.g., K3, K2, K1) may be a modular multiplication product of a negative inverse of the modulus number and a respective auxiliary number of the first plurality of auxiliary numbers, e.g., K1=P1·K0 mod 2^{r}, K2=P2·K0 mod 2^{r}, K3=P3·K0 mod 2^{r}. Determining the final quotient value may further include adding the multiplication product Q′×K0 to the sum Q0×K3+Q1×K2+Q2×K1) and taking the least significant word of the result.

As depicted with block 464, obtaining the Montgomery multiplication product of the first number and the second number may also include computing multiplication products of the final quotient value (e.g., Q3) and each of a plurality of words of the modulus number (e.g., words P[j] of modulus P), as illustrated with the last round of multiplications 208 in FIG. 2. obtaining the Montgomery multiplication product of the first number and the second number may further include computing sums of the multiplication operations, e.g., as illustrated with rounds of addition operations of boxes 209-A, 210-A, 211-A, and 212-A in FIG. 2.

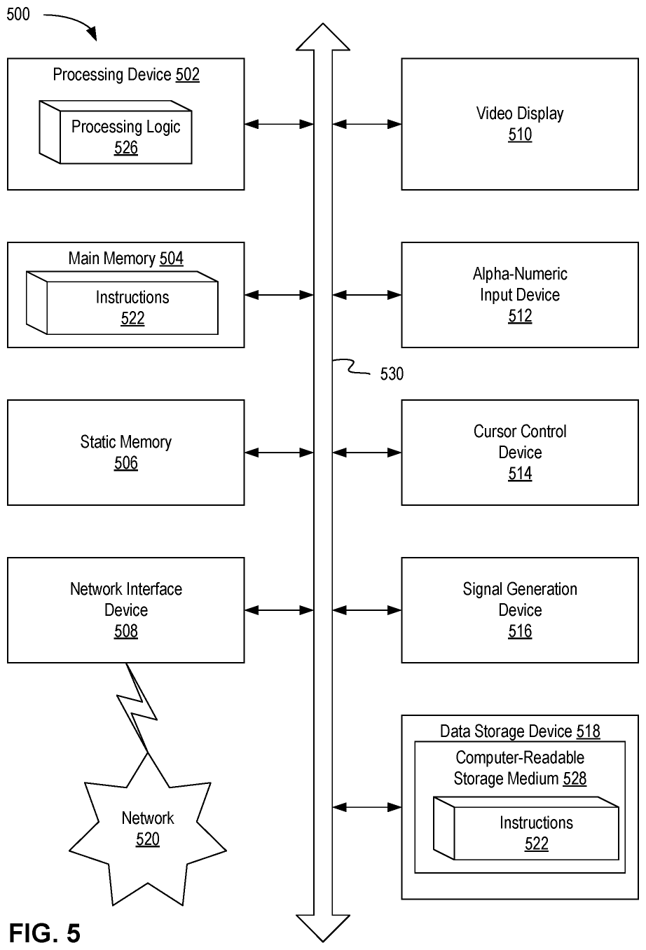

FIG. 5 depicts a block diagram of an example computer system 500 operating in accordance with some implementations of the present disclosure. In various illustrative examples, example computer system 500 may include computing device 100, illustrated in FIG. 1. Example computer system 500 may be connected to other computer systems in a LAN, an intranet, an extranet, and/or the Internet. Computer system 500 may operate in the capacity of a server in a client-server network environment. Computer system 500 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 500 may include a processing device 502 (also referred to as a processor or CPU), a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory (e.g., a data storage device 518), which may communicate with each other via a bus 530.

Processing device 502 represents one or more general-purpose processing devices such as a microprocessor, central processing unit, or the like. More particularly, processing device 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 502 may be configured to execute instructions implementing method 400 of efficient Montgomery multiplications with reduced interdependencies.

Example computer system 500 may further comprise a network interface device 508, which may be communicatively coupled to a network 520. Example computer system 500 may further comprise a video display 510 (e.g., a liquid crystal display (LCD), a touch screen, or a cathode ray tube (CRT)), an alphanumeric input device 512 (e.g., a keyboard), a cursor control device 514 (e.g., a mouse), and an acoustic signal generation device 516 (e.g., a speaker).

Data storage device 518 may include a computer-readable storage medium (or, more specifically, a non-transitory computer-readable storage medium) 528 on which is stored one or more sets of executable instructions 522. In accordance with one or more aspects of the present disclosure, executable instructions 522 may comprise executable instructions implementing method 400 of efficient Montgomery multiplications with reduced interdependencies.

Executable instructions 522 may also reside, completely or at least partially, within main memory 504 and/or within processing device 502 during execution thereof by example computer system 500, main memory 504 and processing device 502 also constituting computer-readable storage media. Executable instructions 522 may further be transmitted or received over a network via network interface device 508.

While the computer-readable storage medium 528 is shown in FIG. 5 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, the intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause the computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method to compute a Montgomery multiplication product, modulo a modulus number, of a first number and a second number, the method comprising:
accessing a first plurality of auxiliary numbers associated with the modulus number and a Montgomery radix value;
performing a first plurality of iterations, each of the first plurality of iterations comprising:
updating an accumulator with multiplication products of a respective word of a plurality of words of the first number and each of a plurality of words of the second number; and
determining, based on the updated accumulator, a respective quotient value of a plurality of quotient values;
performing a second plurality of iterations, each of the second plurality of iterations comprising:
updating the accumulator using multiplication products of a quotient value of the plurality of quotient values and each of a plurality of words of a respective auxiliary number of the first plurality of auxiliary numbers; and
obtaining the Montgomery multiplication product of the first number and the second number using the updated accumulator.

2. The method of claim 1, further comprising:
accessing a second plurality of auxiliary numbers associated with the modulus number; and
obtaining a final quotient value using a sum of multiplication products of each quotient value of the plurality of quotient values and a respective auxiliary number of the second plurality of auxiliary numbers.

3. The method of claim 2, wherein obtaining the Montgomery multiplication product of the first number and the second number comprises:
computing multiplication products of the final quotient value and each of a plurality of words of the modulus number.

4. The method of claim 2, wherein each of the second plurality of auxiliary numbers is a modular multiplication product of a negative inverse of the modulus number and a respective auxiliary number of the first plurality of auxiliary numbers.

5. The method of claim 2, wherein obtaining the final quotient value comprises performing a third plurality of iterations, wherein each of the third plurality of iterations is performed concurrently with an iteration of the first plurality of iterations or an iteration of the second plurality of iterations, and wherein each of the third plurality of iterations comprises computing a multiplication product of a quotient value of the plurality of quotient values and a respective auxiliary number of the second plurality of auxiliary numbers.

6. The method of claim 1, wherein determining a first quotient value of the plurality of quotient values comprises:
identifying a least significant word of the accumulator as the first quotient value.

7. The method of claim 6, wherein determining a second quotient value of the plurality of quotient values comprises:
eliminating the least significant word of the accumulator;
updating the accumulator with additional multiplication products; and
identifying a least significant word of the updated accumulator as the second quotient value.

8. The method of claim 1, wherein a number of words of the first number comprises n words, and wherein the Montgomery multiplication product of the first number and the second number is obtained using n+4 sets of concurrent multiplication operations, each of the n+4 sets comprising n or n+1 concurrent multiplication operations.

9. The method of claim 1, wherein a number of words of the first number comprises n words, wherein n is greater than four, the method further comprising:
performing a plurality of preliminary iterations, each of the plurality of preliminary iterations comprising:
determining a preliminary quotient value based on the accumulator; and
updating the accumulator using a multiplication product of the preliminary quotient value and a first auxiliary number of the first plurality of auxiliary numbers.

10. A system comprising:
a memory device; and
a processing device, communicatively coupled to the memory device, the processing device is to:
access a first plurality of auxiliary numbers stored in the memory device, wherein the first plurality of auxiliary numbers is associated with a modulus number and a Montgomery radix value;
performing a first plurality of iterations, wherein during each of the first plurality of iterations the processing device is to:
update an accumulator with multiplication products of a respective word of a plurality of words of a first number and each of a plurality of words of a second number; and
determine, based on the updated accumulator, a respective quotient value of a plurality of quotient values;
perform a second plurality of iterations, wherein during each of the second plurality of iterations the processing device is to:
update the accumulator using multiplication products of a quotient value of the plurality of quotient values and each of a plurality of words of a respective auxiliary number of the first plurality of auxiliary numbers; and
obtain a Montgomery multiplication product of the first number and the second number using the updated accumulator.

11. The system of claim 10, wherein the processing device is further to:
access a second plurality of auxiliary numbers associated with the modulus number; and
obtain a final quotient value using a sum of multiplication products of each quotient value of the plurality of quotient values and a respective auxiliary number of the second plurality of auxiliary numbers.

12. The system of claim 11, wherein to obtain the Montgomery multiplication product of the first number and the second number the processing device is to:
compute multiplication products of the final quotient value and each of a plurality of words of the modulus number.

13. The system of claim 11, wherein each of the second plurality of auxiliary numbers is a modular multiplication product of a negative inverse of the modulus number and a respective auxiliary number of the first plurality of auxiliary numbers.

14. The system of claim 11, wherein to obtain the final quotient value the processing device is to perform a third plurality of iterations, wherein each of the third plurality of iterations is performed concurrently with an iteration of the first plurality of iterations or an iteration of the second plurality of iterations, and wherein to perform each of the third plurality of iterations the processing device is to:
compute a multiplication product of a quotient value of the plurality of quotient values and a respective auxiliary number of the second plurality of auxiliary numbers.

15. The system of claim 10, wherein to determine a first quotient value of the plurality of quotient values the processing device is to:
identify a least significant word of the accumulator as the first quotient value.

16. The system of claim 15, wherein to determine a second quotient value of the plurality of quotient values the processing device is to:
eliminate the least significant word of the accumulator;
update the accumulator with additional multiplication products; and
identify a least significant word of the updated accumulator as the second quotient value.

17. The system of claim 10, wherein a number of words of the first number comprises n words, and wherein the Montgomery multiplication product of the first number and the second number is obtained using n+4 sets of concurrent multiplication operations, each of the n+4 sets comprising n or n+1 concurrent multiplication operations.

18. The system of claim 10, wherein a number of words of the first number comprises n words, wherein n is greater than four, and wherein the processing device is further to:
perform a plurality of preliminary iterations, wherein during each of the plurality of preliminary iterations the processing device is to:
determine a preliminary quotient value based on the accumulator; and
update the accumulator using a multiplication product of the preliminary quotient value and a first auxiliary number of the first plurality of auxiliary numbers.

19. An accelerator circuit comprising:
one or more registers to store a first set of auxiliary numbers and a second set of auxiliary numbers, wherein each auxiliary number of the first set of auxiliary numbers and each auxiliary number of the second set of auxiliary numbers are associated with a modulus number and a Montgomery radix value; and
a plurality of multiplication circuits to:
compute a first set of multiplication products comprising multiplication products of each word of a first number and each word of a second number; and
one or more addition circuits to:
determine, using the first set of multiplication products, a set of quotient values; and
wherein the plurality of multiplication circuits is further to:
compute a second set of multiplication products comprising multiplication products of each quotient value of the set of quotient values and each word of a corresponding auxiliary number of the first set of auxiliary numbers;
wherein the accelerator circuit further comprises:
an additional multiplication circuit to:
compute a third set of multiplication products comprising multiplication products of each quotient value of the set of quotient values and a corresponding auxiliary number of the second set of auxiliary numbers;
wherein the one or more addition circuits are further to:
determine, using the third set of multiplication products, a final quotient value;
wherein the plurality of multiplication circuits are further to:
compute a fourth set of multiplication products comprising multiplication products of the final quotient value and each word of the modulus number; and
wherein the one or more addition circuits are further to:
obtain, using the third set of multiplication products and a fourth set of multiplication products, a Montgomery multiplication product of the first number and the second number.

20. The accelerator circuit of claim 19, wherein the plurality of multiplication circuits contains four multiplication circuits.
